(19) United States
(12) Patent Application Publication
(10) Pub. No.: US 2013/0043050 A1
(43) Pub. Date: Feb. 21, 2013

(54) SPRINKLER DEVICE FOR SPRAYING NON-CIRCULAR AREAS

(71) Applicants: Felix BARMOAV, Rishon Lezion (IL); Haim SLOTIN, Oranit (IL)

(72) Inventors: Felix BARMOAV, Rishon Lezion (IL); Haim SLOTIN, Oranit (IL)

(21) Appl. No.: 13/585,635

(22) Filed: Aug. 14, 2012

Related U.S. Application Data
(60) Provisional application No. 61/523,598, filed on Aug. 15, 2011.
(60) Provisional application No. 61/536,008, filed on Sep. 18, 2011.
(60) Provisional application No. 61/591,925, filed on Jan. 29, 2012.
(60) Provisional application No. 61/591,927, filed on Jan. 29, 2012.

(51) Int. Cl. A62C 31/02; B05B 1/26

(52) U.S. Cl. 169/37; 239/518; 239/498

(57) ABSTRACT

Upright and pendent sprinkler devices for spraying non-circular or semi non-circular areas are disclosed. The upright sprinkler device comprises a deflector having an uneven surface designed to cause flow of liquid meeting the deflector to reach a distance that changes respective of the uneven surface to cover a non-circular spraying area; and a frame having a first end connected to a pipe and a second end connected to a bottom portion of the deflector, wherein the first end is an inlet end and the second end is an outlet end, thereby allowing the liquid to flow from the pipe towards the deflector

### CROSS REFERENCE TO RELATED APPLICATION

This application claims the benefit of U.S. provisional application No. 61/523,598 filed Aug. 15, 2011, U.S. provisional application No. 61/536,008 filed Sep. 18, 2011, U.S. provisional application No. 61/591,925, filed Jan. 29, 2012, and U.S. provisional application No. 61/591,927 filed Jan. 29, 2012. The contents of each of the above-referenced provisional applications are herein incorporated by reference.

### TECHNICAL FIELD

The present invention generally relates to sprinkler devices used for fire extinguishing systems that are used for spraying of fire suppressant liquids such as water, and more particularly, to sprinkler devices for spraying non-circular or semi non-circular areas.

### BACKGROUND

Spray type sprinklers are well known in the art of fire suppressing or fire extinguishing and are typically used for spraying of buildings both residential and industrial. Most of the sprinklers provide various degrees of coverage of areas where typically the pattern covers a circle or a semi-circle area in a fan-type of spray.

Circular spraying around the sprinkler requires large overlaps between the sprinklers to ensure proper area coverage. The solutions discussed in the related art, result in either wasting water or other fire suppressant liquids, or under watering because certain areas are not covered by the sprinkler system. Prior art solutions provide liquid spraying for non-circular shapes, particularly rectangles. However, these solutions are complex and far from providing appropriate coverage.

An example is shown in FIG. 1A in diagram 100A where a sprinkler 110 is configured to spray a square area 100. If adjusted such that the sprinkler sprays on the length of the rectangular using spraying lines 140 the area sprayed 120 is smaller than the area of the square 100. This would result in several non-sprayed areas 130, and in these areas 130 fire can continue to burn thereby causing severe damage. Conversely, in the case shown in FIG. 1B the sprinkler 110 is adjusted to spray on the diagonal of the square 100. As a result the entire square area is sprayed. However, additional areas 150 are sprayed as well resulting in over-spraying and waste of water.

FIGS. 2A and 2B show attempts to provide a better coverage using sprinklers that allow not only adjustment of the sprinkling radius, but also of the angle of coverage.

Specifically, in the cases shown in FIG. 2A and 2B the angle of coverage of each sprinkler 210 is 90 degrees. In the case depicted in FIG. 2A, there are some areas 230 that are left unsprayed while in the case depicted in FIG. 2B there is an over-spraying of areas 250. Thus, none of these situations provide the desired outcome.

As a result of the deficiencies of the circular and semi-circular sprinkler solutions there have been made attempts to provide various rectangular sprinkling solutions. The solutions discussed in the related art typically use moving parts, are complex to operate, have a relatively low reliability, and are high in cost. Moreover, none of the prior art solutions deal effectively with odd shaped areas that require spraying. Sprinklers that spray square, rectangular, and partial surfaces thereof exist, but they cannot be adjusted and their spraying surfaces are determined during the manufacturing process and therefore are permanent. These permanent spraying patterns might cause over-spraying or under-spraying of areas as noted above.

It would be therefore advantageous to provide a solution where a sprinkler can be adjusted to cover a predetermined area pattern that is different from a circle or semi-circle. It would be further advantageous if such a solution does not require the use of moving parts.

### SUMMARY

Certain embodiments disclosed herein include an upright sprinkler device for spraying non-circular areas. The upright sprinkler device comprises a deflector having an uneven surface designed to cause flow of liquid meeting the deflector to reach a distance that changes respective of the uneven surface to cover a non-circular spraying area; and a frame having a first end connected to a pipe and a second end connected to a bottom portion of the deflector, wherein the first end is an inlet end and the second end is an outlet end, thereby allowing the liquid to flow from the pipe towards the deflector.

Certain embodiments disclosed herein also include a pendent sprinkler device for spraying non-circular areas. The pendent sprinkler device comprises a deflector having an uneven surface designed to cause flow of liquid meeting the deflector to reach a distance that changes respective of the uneven surface to cover a non-circular spraying area; and a frame having a first end connected to a pipe and a second end connected to a top portion of the deflector, wherein the first end is an inlet end and the second end is an outlet end, thereby allowing the liquid to flow from the pipe towards the deflector.

Certain embodiments disclosed herein also include a deflector utilized in a fire extinguishing device for spraying liquid around non-circular areas. The deflector comprises a lateral surface determined by a radius that changes around a height axis of the deflector, the lateral surface having at least one first angle that determines a first spraying distance from a center of the deflector for deflection of liquid hitting the deflector and at least one second angle that determines a second spraying distance from the center of the deflector for deflection of liquid hitting the deflector.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1A is a diagram of a square area with a sprinkler having a radius coverage along the length of the square resulting in under spraying of liquid;

FIG. 1B is a diagram of a square area with a sprinkler having a radius coverage along the diagonal of the square resulting in over spraying of liquid;

FIG. 2A is a diagram of a square area with two sprinklers placed at opposite corners of the square, each having watering radius to the center of the square and a 90 degrees sprinkling limit, resulting in under spraying of liquid;

FIG. 2B is a diagram of a square area with two sprinklers placed at opposite corners of the square, with a watering radius to the close corner of the square and a 90 degrees sprinkling limit, resulting in over spraying of liquid;

FIG. 3A is a schematic diagram of a top view of a deflector having a lateral surface according to an embodiment disclosed herein;

FIG. 3B is a schematic diagram of a bottom view of the deflector having a lateral surface according to an embodiment disclosed herein;

FIGS. 3C and 3D are isometrics of the deflector;

FIG. 3E shows the assembly of the deflector in upright and pendent sprinkler devices;

FIG. 4A is a front view of an upright sprinkler device structured according to one embodiment;

FIG. 4B is a side view of the upright sprinkler device of FIG. 4A;

FIG. 5A is a front view of a pendent sprinkler device structured according to another embodiment;

FIG. 5B is a schematic diagram of a pendent sprinkler device of FIG. 5A;

FIG. 6 is a cross section view illustrating a spraying pattern of the pendent sprinkler device;

FIG. 7 is a cross section view illustrating the spraying pattern of the upright sprinkler device;

FIG. 8 is an isometric view of the upright sprinkler device;

FIG. 9 is an isometric view of the pendent sprinkler device; and

FIG. 10 is a diagram of the spraying pattern according to an embodiment disclosed herein.

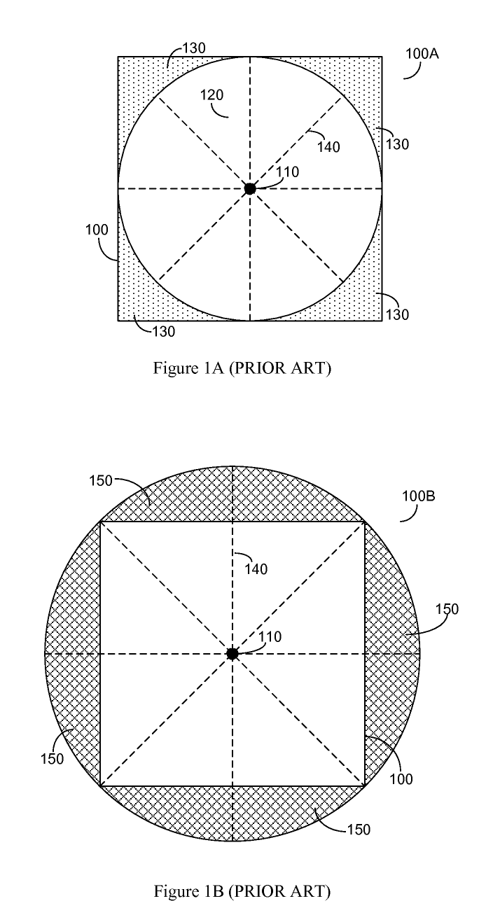

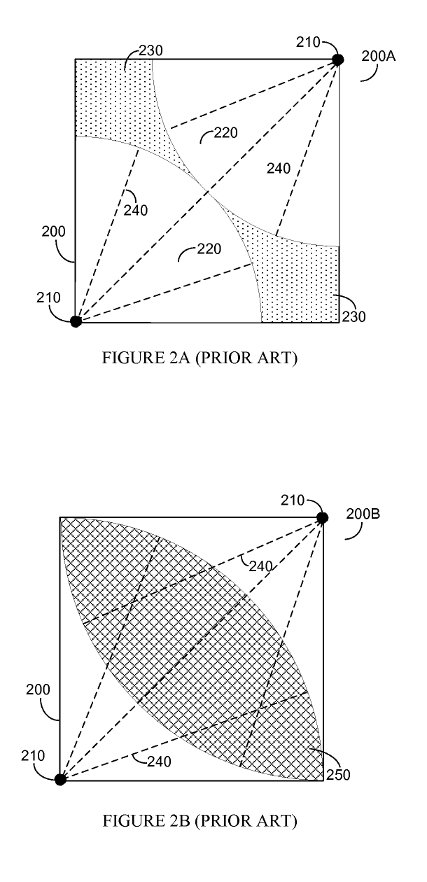

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The sprinkler devices disclosed herein are designed for spraying a non-circular or semi non-circular area. In one embodiment, the sprinkler device includes a deflector having a lateral surface determined by a changing radius. The changing radius determines the deflection of the liquid that hits the deflector. In another embodiment, the sprinkler device includes a deflector having curved surfaces to determine the deflection of the liquid that hits the deflector. As a result of the different angles of the lateral surface, the liquid is deflected to spray at variables distances from the center of the deflector, thereby allowing spraying of non-circular or semi-circular areas. Therefore, the variable radius deflector provides coverage for both regular shaped areas, for example, an oval, a rectangle, a parallelogram, a trapeze, a pentagon, a hexagon, and the like, as well as irregular shaped areas, thereby preventing unnecessary liquid waste.

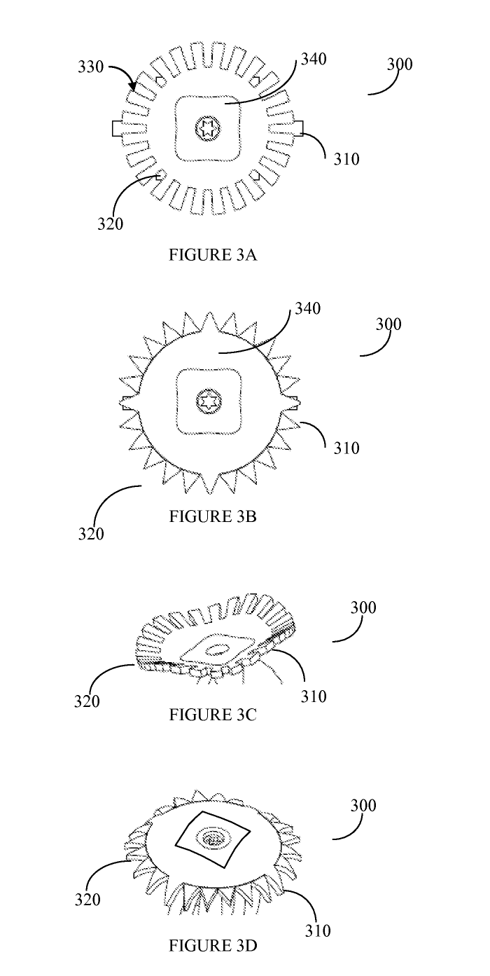

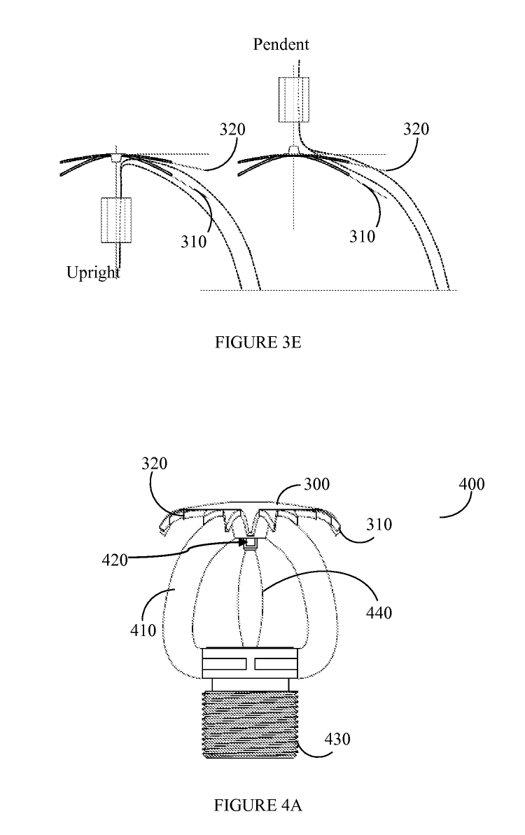

FIGS. 3A and 3B depict exemplary and non-limiting schematic diagrams of a deflector 300 having a lateral surface designed according to one embodiment. The deflector 300 is to be used with respect of a sprinkling device that sprinkles water, a fire suppressing liquid or fluid, or a fire extinguishing liquid or fluid. The deflector 300 includes an uneven curved surface that is partially deep angled 310 and peak angled 320. The deflector 300 includes an indicator 340 that provides an indication allowing a user (e.g., technician installing the sprinkler) to align the deflector 340 with the shape of the spraying area to provide an optimal spraying coverage. With this aim, the corners and edges of the indicator 340 provide an indication to the user as whether the deflector 300 is aligned with the circumference and corners of the rectangular spraying area (e.g., room's walls and corners).

The deflector 300 also includes a plurality of tines and open-ended slots (e.g., slot 330 shown in FIG. 3A) around the circumference of the deflector 300. However, it should be noted that the curvature of the deflector's surface allows the coverage of non-circular and semi non-circular areas as discussed in greater detail herein below. The curvature of the lateral surface of the deflector 300 is clearly depicted in the isometric views provided in FIGS. 3C and 3D. Specifically, it should be noted that the deep and peak angles of the deflector 300 change continuously from a peak angle to a deep angle in a continuous wave to form a curved-shape surface. It should be further noted that the number of peak and deep angles determine the shape of the non-circular or semi non-circular spraying area.

The deflector 300 can be installed in an upright or pendent sprinkler device as shown in FIG. 3E and further discussed in greater detail below.

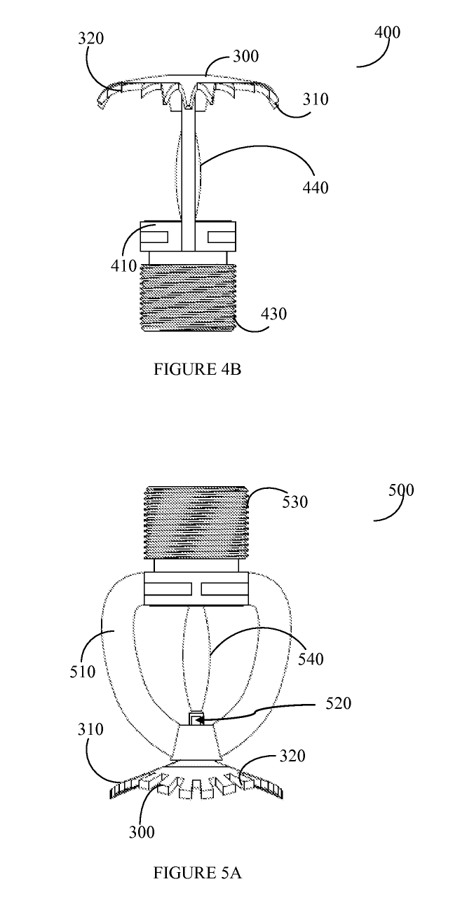

FIGS. 4A and 4B depict exemplary and non-limiting schematic diagrams of an upright sprinkler device 400 structured according to one embodiment. The upright sprinkler device 400 includes the deflector 300 connected to a frame 410 having a base portion 430. Further coupled to the frame 410 of the sprinkler 400 is a thermally responsive element 440 that keeps the sprinkler device 400 from spraying when a predetermined temperature is reached. In the upright configuration, the frame 410 is connected, e.g., by any fastening means, to the bottom portion (see FIG. 3B) of the deflector 300.

It should be noted that, in one embodiment, once the sprinkler frame 410 is screwed onto the pipeline, then the correct position of the deflector 300 is set, such that the spraying coverage would be within the walls and the corners of the room. This can be achieved when the corners of the rooms are in direct position with the peak angle (320) (and/or the corners of the indicator 340) and the deep angle (310) is perpendicular to the room walls (and/or or the edges of the indicator 340.

Thus, the fastening means should allow for the adjustment of the deflector 300. However, once the deflector's position is set, it must then be firmly secured to the frame 410 such that it will remain stable even when the deflector 300 is exposed to extreme environmental conditions, such as very high or low temperatures, vibration, and so on.

The base portion 430 of the frame 410 has a screw thread (ribs) 430 to be screwed onto a liquid source, such as a tube, a pipe, and the like. An internal passageway extends between an inlet end (at the base portion 430) and an opposite outlet end 420 to allow the liquid to flow from the inlet end to the outlet end 420 and hit the deflector 340.

According to the various embodiments disclosed herein, the surface of the deflector 300 is shaped as an uneven curved surface that is partially deep angled 310 and peak angled 320. The liquid flows out of the outlet 420 and hits the inner deflector's 350 curved surface, thus deflecting flow of liquid generally outward and downward of the sprinkler 400, but generally opposite to direction of flow through the passageway.

It is important to emphasize that the number and location of deep angles 310 and peak angles 320 can vary depending on a configuration of the sprinkler and the spraying application. It is not even necessary that these angles be at identical distance from each other (i.e., no symmetry is required). However, if the distances are equal, then spraying coverage for symmetrical shapes, such as triangles, squares, pentagons, hexagons, and the like may be reached. Furthermore, if as the radius rotates about its center and length varies for different peak angles 320 and/or different deep angles 310, then spraying coverage for other shapes, such as rectangles, parallelograms, trapezes, as well as other odd shapes may be created.

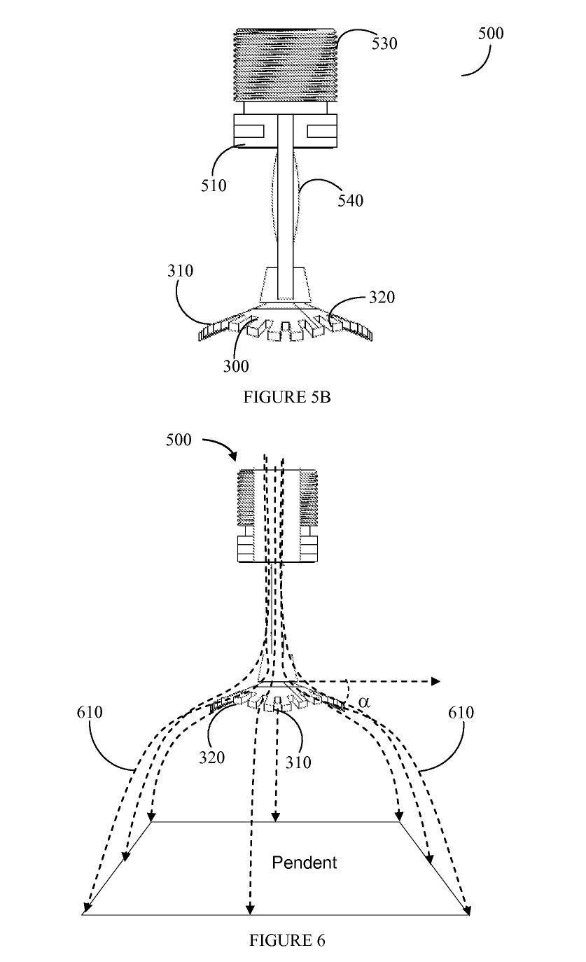

FIGS. 5A and 5B depict exemplary and non-limiting schematic diagrams of a pendent sprinkler device 500 structured according to another embodiment. The pendant sprinkler device 500 includes the deflector 300 connected to a frame 510 having a base portion 530. Further coupled to the frame 510 of the sprinkler device 500 is a thermally responsive element 540 that keeps the sprinkler device from spraying when a predetermined temperature is reached.

An internal passageway extends between an inlet end (at the base 530) and an opposite outlet end 520 to allow the liquid to flow from the inlet end to the outlet end 520. In the pendent configuration, the frame 510 is connected, e.g., by any fastening means, to the top portion (see FIG. 3A) of the deflector 300. The deflector 300 is adjusted to a position that provides optimal spraying coverage. The adjustment is as discussed in detail above. As further noted above, the fastening means should allow for adjustment of the deflector's position and to securely fix the deflector to the frame 510 once the position is set.

As noted above, the surface of the deflector 300 is shaped as an uneven curved surface that is partially deep angled 310 and peak angled 320. The liquid flows out of the outlet 520 and hits the deflector's 300 curved surface, thus deflecting flow of liquid generally outward and downward of the sprinkler 500. This is further illustrated in FIG. 6

FIG. 6 depicts an exemplary and non-limiting cross section view of a pendent sprinkler device 500 utilized to illustrate the flow of the liquid from the device. Liquid 610 hits the deflector's peak-angled and deep angled surfaces (320, 310, respectively) or any surface there between and deflects outwards at an angle α. The angle α is the deflection angle that determines the radius to which the water should reach.

Specifically, the angle a corresponds to the deep angle 310 or the peak angle 320. The peak angle typically determines the diagonal distance for the spraying area having a non-circular shape, i.e., from the center of the deflector to the corners of the non-circular spraying area (e.g., a room). The deep angle typically determines the circumference (e.g., room's walls) distance for the spraying area. Therefore, the value of the angle a (related to the deep angle and/or the peak angle) of the deflector's surface determines the spraying area for the sprinkler device 500.

It should be noted that for the creation of a rectangular spraying area there would be four peak angles and four deep angles. If a different number would be chosen, such as five of each, a pentagon spraying can been created, and so on and so forth.

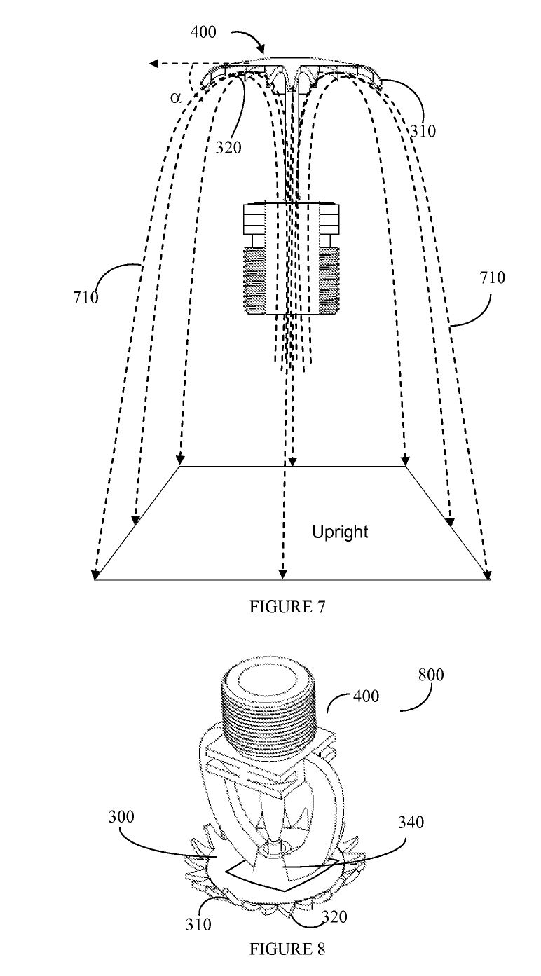

In another embodiment, the peak angle 320 defines the maximum range representing the square corners and deep angle 310 defines the minimum range representing the shortest distance from the sprinkler center to the square sides as illustrated in FIG. 3E, FIG. 6, and FIG. 7.

FIG. 7 depicts an exemplary and non-limiting cross section view of the upright sprinkler device 400 utilized to illustrate the flow of the liquid from the device 400.

Similar to the sprinkler device 500, liquid 710 hits the deflector's peak-angled and deep angled surfaces (320, 310, respectively) or any surface there between and deflects outwards at an angle α. The angle α is the deflection angle that determines the “radius” to which the liquid 710 should reach. As described in detail above, the angle a may correspond to the deep angle 310 and the peak angle 320. The deep angle typically determines the circumference distance or the distance to the edge for the spraying area having a non-circular shape. The peak angle typically determines the diagonal or the distance from the center of the deflector to the corner of the non-circular spraying area.

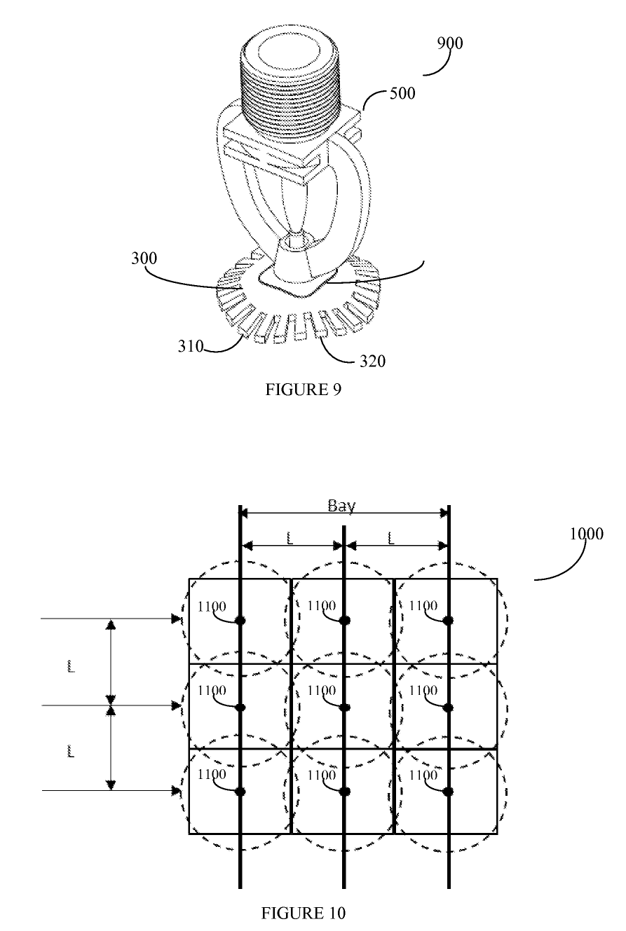

FIG. 8 depicts an exemplary and non-limiting isometric view 800 of the upright sprinkler device 400 described in greater detail with reference to FIG. 4. FIG. 9 depicts an exemplary and non-limiting isometric view 900 of a pendent sprinkler device 900 described in greater detail with reference to FIG. 5. In both views 800 and 900 the curvature of the deflector 300 having deep angled portions (310) and peak angled portions (320) are clearly shown. As noted above, the portions 320 of the surface are peak angles that define the maximum range representing the square corners, and portions 310 of the surface that are deep angles define the minimum range representing the shortest distance from the sprinkler center to the square sides.

As can be further noted from views 800 and 900, the frames of the sprinkler devices 400 and 500 are connected to different portions of the deflector 300. That is, in the upright configuration (800), the frame is coupled to the top portion (see FIG. 3A) of the deflector 300, while in the pendent configuration (900), the frame is coupled to the bottom portion (see FIG. 3B) of the deflector 300.

FIG. 10 depicts an exemplary and non-limiting spraying pattern 1000 of a plurality of sprinkler devices 1100. Each of the sprinkler devices 1100 may be the upright sprinkler device 400 or the pendent sprinkler device 500 discussed in detail above. FIG. 10 also shows the circular pattern (dashed lines) of conventional sprinklers with partial over-coverage and partial under-coverage, as well as the square areas covered by the sprinklers 1100 designed according to the embodiments disclosed herein.

The distance between two sprinkler devices 1100 is marked “L” and the distance between three sprinkler devices 1100 is marked “Bay”. These marks are used in order to demonstrate the square pattern that can be achieved. Specifically, the spraying pattern 1000 demonstrates that when the sprinkler devices 1100 are activated, approximately 8% of the spraying over-coverage and approximately 11% under-coverage are prevented.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What we claim is:

1. An upright sprinkler device for spraying non-circular areas, comprising:
a deflector having an uneven surface designed to cause flow of liquid meeting the deflector to reach a distance that changes respective of the uneven surface to cover a non-circular spraying area; and
a frame having a first end connected to a pipe and a second end connected to a bottom portion of the deflector, wherein the first end is an inlet end and the second end is an outlet end, thereby allowing the liquid to flow from the pipe towards the deflector.

2. The sprinkler device of claim 1, further comprising:
a thermally responsive element for keeping the sprinkler device from spraying when reaching a predetermined temperature.

3. The sprinkler device of claim 1, wherein the surface of the deflector is partially high-angled defined using at least one peak angle and partially low-angled defined using at least one low angle.

4. The sprinkler device of claim 3, wherein a number of each of the at least one peak angle and the at least one deep angle determines a shape of the non-circular spraying area.

5. The sprinkler device of claim 4, wherein the non-circular spraying area further includes a semi non-circular spraying area.

6. The sprinkler device of claim 4, wherein the at least one peak angle defines a maximum range coverage for the non-circular spraying area and the at least one deep angle defines a minimum range coverage for the non-circular spraying area, wherein the minimum range and the maximum range are respective of a center of the deflector.

7. The sprinkler device of claim 1, wherein the liquid is any one of: water, fire suppressing fluid, and fire extinguishing fluid.

8. The sprinkler device of claim 1, wherein the deflector further comprises:
a plurality of tines and a corresponding number of open ended slots arranged about a circumference of the deflector.

9. A pendent sprinkler device for spraying non-circular areas, comprising:
a deflector having an uneven surface designed to cause flow of liquid meeting the deflector to reach a distance that changes respective of the uneven surface to cover a non-circular spraying area; and
a frame having a first end connected to a pipe and a second end connected to a top portion of the deflector, wherein the first end is an inlet end and the second end is an outlet end, thereby allowing the liquid to flow from the pipe towards the deflector.

10. The sprinkler device of claim 1, further comprises:
a thermally responsive element for keeping the sprinkler device from spraying when reaching a predetermined temperature.

11. The sprinkler device of claim 9, wherein the surface of the deflector is partially high-angled defined using at least one peak angle and partially low-angled defined using at least one deep angle.

12. The sprinkler device of claim 11, wherein a number of each of the at least one peak angle and the at least one deep angle determines a shape of the non-circular spraying area.

13. The sprinkler device of claim 11, wherein the at least one peak angle defines a maximum range coverage for the non-circular spraying area and the at least one deep angle defines a minimum range coverage for the non-circular spraying area, wherein the minimum range and the maximum range are respective of a center of the deflector.

14. The sprinkler device of claim 9, wherein the deflector further comprises:
a plurality of tines and a corresponding number of open ended slots arranged about a circumference of the deflector.

15. A deflector utilized in a fire extinguishing device for spraying liquid around non-circular areas, comprising:
a lateral surface determined by a radius that changes around a height axis of the deflector, the lateral surface having at least one first angle that determines a first spraying distance from a center of the deflector for deflection of liquid hitting the deflector and at least one second angle that determines a second spraying distance from the center of the deflector for deflection of liquid hitting the deflector.

16. The deflector of claim 15, further comprises:
a plurality of tines and a corresponding number of open ended slots arranged about a circumference of the deflector.

17. The deflector of claim 15, wherein the surface of the deflector is partially high-angled by the at least one first angle and partially low-angled by the at least one second angle thereby forming a curved-shape surface, wherein the at least one first angle defines a maximum range coverage for the non-circular spraying area and the at least one second angle defines a minimum range coverage for the non-circular spraying area, wherein the minimum range and the maximum range are respective of a center of the deflector.

18. The deflector of claim 17, wherein the at least one second angle determines a spraying distance between a center and circumference of the non-circular spraying area and the at least one first angle determines the diagonal distance of the spraying area.

19. The deflector claim 18, wherein the deflector is positioned on the fire extinguishing device such that the at least one first angle is directed to the corners of the non-circular spraying area, and the at least one second angle is perpendicular to the circumference of the non-circular spraying area, wherein the non-circular spraying area is a room.

20. The deflector of claim 15, wherein the liquid is any one of: water, fire suppressing fluid, and fire extinguishing fluid.
